(19) United States
(12) Patent Application Publication
(10) Pub. No.: US 2022/0116463 A1
(43) Pub. Date: Apr. 14, 2022

(54) REMOTE AUDIENCE PARTICIPATION AT LIVE EVENTS

(71) Applicants: David Price, Fremont, CA (US); Anthony Wechselberger, Escondido, CA (US)

(72) Inventors: David Price, Fremont, CA (US); Anthony Wechselberger, Escondido, CA (US)

(21) Appl. No.: 17/499,824

(22) Filed: Oct. 12, 2021

Related U.S. Application Data
(60) Provisional application No. 63/091,518, filed on Oct. 14, 2020.

(51) Int. Cl. H04L 29/08

(52) U.S. Cl. CPC H04L 67/16; H04L 67/30

(57) ABSTRACT

A method of enabling remote audience participation at a live venue event includes receiving, at an aggregator, media inputs from one or more user device of one or more users in a subscription roster for participation in a live event; generating an aggregated media stream by processing the media inputs; and forwarding the aggregated media stream to a venue of the live event.

### CROSS REFERENCE TO RELATED APPLICATIONS

This patent document claims benefit of priority to U.S. Provisional Patent Application No. 63/091,518, filed on Oct. 14, 2020. The entire content of the before-mentioned patent application is incorporated by reference as part of the disclosure of this application.

### TECHNICAL FIELD

The present document relates to technologies for interactive user participation in live events.

### BACKGROUND

As the shift from linear television and radio content consumption to “any time/any place” consumption has grown apace over the past decade, it remains true that a major type of content consumption, where everyone watches the same thing at the same time, is sports and news. The threat of pandemics (such as COVID-19) has caused aggressive and ubiquitous government actions where large venue events have stopped in-person attendance everywhere. It is increasingly clear to the inventors that this threat may prevail for years to come, and likely repeated. This perfect storm has resulted in events being canceled globally, with unused or empty stadia in almost every sport.

### BRIEF SUMMARY

Various techniques are disclosed to allow users to participate in a live event from a remote location based on an audio and/or video input from the user to create an ambience at the live event.

In one example aspect, a method of enabling remote audience participation at a live venue event is disclosed. The method includes receiving, at an aggregator, media inputs from one or more user device of one or more users in a subscription roster for participation in a live event, generating an aggregated media stream by processing the media inputs, forwarding the aggregated media stream to a venue of the live event.

In another example aspect, another method of providing audience feedback at a live event is disclosed. The method includes receiving, at a venue of a live event, an aggregated media stream comprising multimedia feedback to the live event from a plurality of users, and playing back the aggregated media stream using an audio or visual system at the venue.

In another example aspect, another method of allowing a user to provide live feedback to a live event is disclosed. The method includes providing an audio and/or a visual (AV) signal corresponding to a multimedia signal from a venue of a live event, capturing a user feedback to the AV signal, and providing a media stream carrying the user feedback to an aggregator.

In another example aspect, an apparatus for implementing an above-described method is disclosed.

In yet another aspect, a system for implementing the above described method is disclosed.

In yet another aspect, an apparatus comprising a processor for implementing a method described herein is disclosed.

In yet another example aspect, a computer readable storage medium having processor-executable code for implementing a method described herein is disclosed.

In another example aspect, a computer-readable storage medium having a media stream generated according to any of the techniques described herein is disclosed.

These, and other aspects, are further described throughout the document.

### BRIEF DESCRIPTIONS OF THE DRAWINGS

Various embodiments are illustrated by way of example, and not by way of limitation. In the drawings in which like elements perform similar functions the elements are referenced the same.

FIG. 1 is a diagram depicting the generalized RAVE system architecture.

FIG. 2 is a diagram depicting a single RAVE service entity in a distributed aggregation architecture.

FIG. 3A is a diagram depicting separate, team-oriented, service entities.

FIG. 3B is a diagram depicting another example of separate, team-oriented entities.

FIG. 4 is a flow diagram of participant processes.

FIG. 5 is a flow diagram of service entity event process flow.

FIG. 6 is a diagram depicting the generic hardware architecture typical of a subscriber interactive appliance (e.g., tablet), aggregation processor or venue AN processor.

FIG. 7 is a work flow depiction of the steps shown in FIGS. 4 and 5.

### DETAILED DESCRIPTION

Section headings are used in the present document to improve readability. Description of a technique in a given section is not intended to limit use of the technique only to that section. As such, techniques described in different sections can be combined in many different ways.

The impact on live sporting events is just one of many examples of the social impact of pandemics. Distance learning, telecommuting, telemedicine and even remote worship are expected to be impacted examples of the new normal. Attempts to maintain a TV audience for some forms of sporting events have largely been spotty. For instance, one of the live events on ESPN was the American Cornhole League playing to an empty venue with players wearing facemasks, observing strict social distancing rules: Televised for a less than riveting sports broadcast.

TV stations, broadcasters, pay-tv operators, sports franchise owners, team owners, stadium owners, and of course fans have all been impacted. To date, the inventors have noted the only recourse appears to have these events played to empty stadia to at least see if stakeholders can salvage some revenue from TV broadcast rights. As sports events playing to empty stadia emerge so have efforts to somewhat mitigate the emotional impact on the event experience through the synthetic addition of pre-recorded fan noise to the feed distributed to the viewers of the live broadcast. Furthermore, from the data available from this and previous pandemics, there is a growing body of evidence that it could take years for redesigned sporting venues to be considered safe enough to be able to host a substantial number of fans as an audience.

There is thus a need to reclaim a semblance of intimacy between players/teams and a live audience capable of interacting with the field action. The inventive solution brings sporting events back to life while avoiding the risk of non-social distancing. The method and system may be utilized with any venue application that might benefit from enabling such live remote participation. The invention applies capabilities available (a) in currently implemented communications networks, such the Internet and World Wide Web (WWW), and (b) present in most modern homes, such as high speed Internet connectivity, with (c) consumer appliances capable of rendering streaming audio/video content and implementing video conferencing.

Historically, fans have voiced their excitement, and disappointment vocally at the venue, and the crowd noise and real-time responses to field action is central and critical to the atmosphere, and thus the enjoyment of attending, and participating in, a live sports event for fans and players/teams alike. The present invention arranges (1) for remote audience participation—for example, from home and/or tavern locations—with the associated remotely generated audio (local to audience participants), (2) to be aggregated and delivered to and then sounded out at the event venue (3) as compiled remote audio, broadcast locally as event audience crowd noise. The method is hereinafter referred to as a “remote audience venue event” (RAVE).

Just like Microsoft Teams, Zoom, Google Meet and others have transformed the workplace and schoolroom by enabling remote interactive live meetings, it is the inventors' belief that the invention can similarly transform the empty stadia sporting venue and its perceived value to those viewing remotely. It brings authentic (as opposed to canned or simulated) and real-time live crowd feedback to the venue, adding to the motivation and excitement of the players and to the enjoyment of the participating viewing members, who experience a two-way engagement with the players as well as the entire audience.

While the above noted workplace and schoolroom facilities can enable a plurality of remote participants to enjoy live interaction including the rendering of audio and/or video information to a room of local participants, the inventors are unaware of any solution that does so at scale, facilitated by an aggregation and synchronization compensation process as described below.

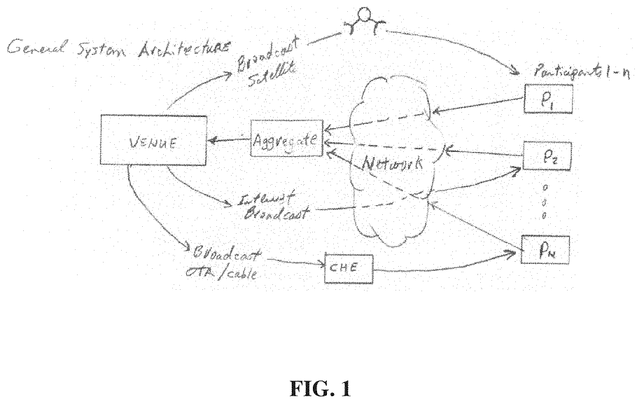

FIG. 1 shows the RAVE generalized architecture, consisting of participants P (which may be at a location with a plurality of users) that receive a broadcast of the event, and communicate their live audio (and optionally video) information to an aggregator over a network. The aggregator compiles and synchronizes the participant audio (and video), and provides the information to the venue for sounding as live crowd noise. In FIG. 1, on the left, there is a venue. The venue provides content via communication channels such as a broadcast satellite channel through a satellite to some participants, internet multicast or broadcast to some participants and through broadcast over the top or cable channels to some participants. The venue receives a composite media stream from an aggregator, where the aggregator is configured to receiver media streams from the participants, process the media streams to generate the composite media stream that is provided to the venue.

### 1. RAVE Preparations

Users wishing to participate in a remote audience venue event (RAVE) first subscribe with a RAVE service entity. Preferably there are a plurality of such entities, each of which may focus on or specialize in different types of events, such as a particular sport or playoff series. The subscription process may identify the user and may include the user indicating one or more preferred monikers (e.g., handles), which may be aligned with different RAVE service entities or event types. For example, in social networking circles a fan may wish to have a preferred moniker they use with NASCAR racing and another for Indy car racing. The monikers may align with the affiliation declarations, as discussed below.

The subscription identity may represent one or more persons (e.g., one or more family members) or a physical location such as an address. In the case of the former, multiple identities may be associated with a physical location. The subscription identity is the principle way a RAVE service entity tracks, interacts with and manages their respective customer bases.

For purposes of clarity, the terms “user,” “subscriber” or “participant” as used hereinafter are meant to be aligned with the subscription identity. A user/subscriber/participant may subscribe with a plurality of RAVE entities. It is envisioned that the user will typically be a person or persons at an event-watching environment, for example, a family room or sports bar. Thus, a head of household or barkeeper can prepare for RAVE participation via the subscription process, and the RAVE service entities can likewise plan accordingly.

The subscription process may be part of or coincident with an event registration process. Event registration is preferably directed to a specific event, or series of connected events. Examples of the former may be a particular game, and of the latter may be a sport's playoff series. RAVE management may require registration to be completed prior the start of an event, or may elect to enable this to take place during an event.

To entice registration, RAVE participation may be allowed, for example, for a limited period of time, subject to completion of the registration process. Other means of enticement may be by throttling access to or interaction with any of the RAVE features or functions, in full or partially, subject to completion of registration. Alternatively, the RAVE service entity may elect to bypass registration and rely upon subscription alone.

The subscription and registration requirements processes are defined by the RAVE service entity in conjunction with their application partners (e.g., sports league owners/managers, etc.) and may be different or change based upon a number of event, business or other factors. Examples may be the event type, size of the participating audience, number and/or duration of events for a given registration, or whether a RAVE service entity decides that subscriptions or registrations should have a constrained time window, after which re-subscription or reregistration may be required.

The RAVE service entity may thus establish a longer term participant relationship via the subscription process, and customize processes and interaction through registration, the latter being directed to event-specifics. This also enables participants to be longer term subscribers, but engage/disengage more or less according to their habits and preferences via the registration process. And as noted above, RAVE service entities are free to experiment with the boundaries of subscription and registration, and blend their respective characteristics as desired.

Stakeholders may implement a variety of monetization factors, such as a subscription enrollment and/or registration fees, and experiment with how revenues are derived, utilized and received. RAVE expenses may be supported, for example, by broadcast advertisement revenues that are derived and split differently between pre-game, live game and post-game activity periods. This may be combinations of participation that is initially free and transitions to fee-based for different periods. A similar revenue structure could be developed on a longer term scale, for example where participation is free for preseason games but fee-based for regular season games, including increased fees for final playoffs. Of course these options may be combined with loyalty programs designed to encourage participation, for example, via reduced fees with greater participation and/or crediting new subscribers.

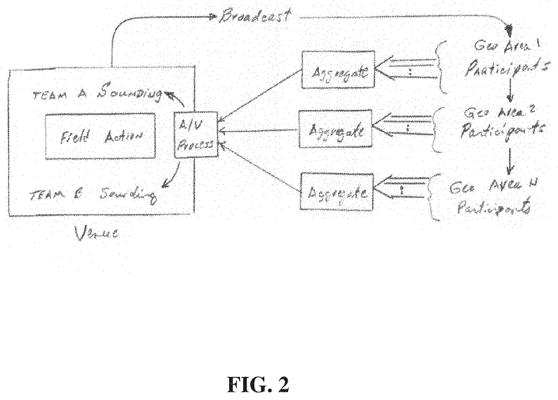

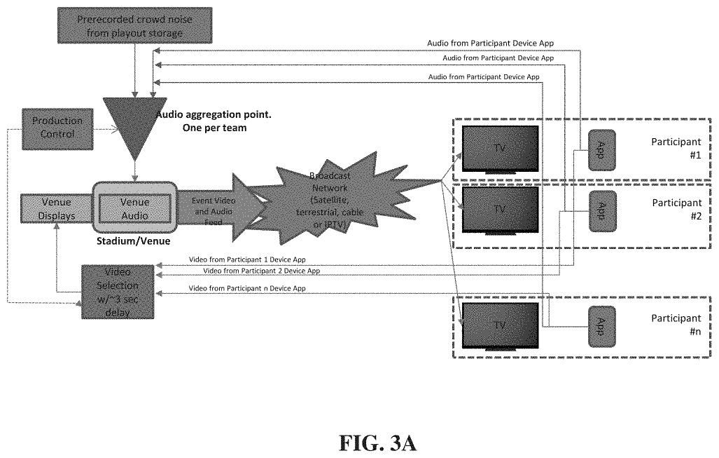

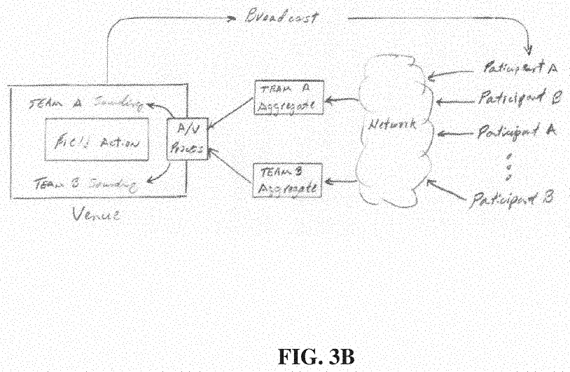

As depicted in FIG. 2, a single service entity may support RAVE operations on behalf of all stakeholders for any given event, series, season etc. In FIG. 2, on the right hand side, many participants in different geographic areas are depicted. Based on geographic areas, corresponding multiple aggregation functions may be implemented, which all feed their putputs to an audio-video process near the venue for playing back user feedback at the venue. Alternatively, as shown in FIG. 3B, separate service entities having their own respective aggregation processes may support each team, league, etc. In the latter case subscription and/or registration may be similarly supported based on teams or other category. For example, a league-wide service entity may support all participant subscription processes, while separate service entities may support team or game oriented registration processes. Additionally, deployments may implement combinations of the architectures of FIGS. 1 and 2. For example, a given team “A's” aggregation as shown in FIG. 2 may advantageously be implemented at multiple aggregation points as shown in FIG. 1.

### 2. Event Participation

When a subscriber registers for a RAVE they may declare their affiliation with one or more event-related categories, for example, with one team or the other. Other category examples may be a particular fan club, sports league, a particular driver, rider or horse, religion, political association, school, sponsor, etc. Affiliations may also be associated with non-event categories, such as family name, employer, city, etc. These categories are exemplary, and will be understood to not limit the scope of the invention. Of course, affiliate declarations may also be designated during the subscription process, and may thus be managed like, or be the same as, subscription monikers.

When the activity around an event starts the subscriber connects to an event-related on-line site (e.g., URL, social networking page, etc.) using their preferred personal device (e.g., smart TV, tablet, etc.), which is capable of live event audio/video broadcast reception, and at least real-time audio capture and delivery to aggregation (discussed below) from the participant's location. The starting of any given event's activity preferably includes pre-game venue-based features, such as player interviews, announcer discussions that engage the registered participants—essentially anything leading up to the start of competition that can be leveraged to capture the subscriber's interest to interactively participate.

The audio from the subscriber location (which may include the audio of participants accompanying or local to the subscriber) is fed back (e.g. streamed) to the venue (e.g., stadium, auditorium, etc.) via an aggregator. At aggregation, the feeds are compiled, and may be synchronized (described below), to form one or more audio signals that are delivered to the venue. The compilation process may combine the audio streams into defined categories, for example according to team affiliation, which allows them to be fed to distinct (separate) loudspeaker arrangements (e.g., each side or end of a stadium).

Subscribers may elect to observe and interact with the event action in different ways. For example, they may watch the event on their television and interactively participate with the event (feeding local audio and optionally a video stream to the aggregator) via a computer, tablet, smart phone, etc. Alternatively, all user observing and interacting activity may be via a computer, tablet, smart phone, smart TV, etc.

Participants may preferably subscribe and/or register using an application (“app”) that is downloaded to their smart device(s), and such app may also provide the real-time interface for capturing the local audio (and video) information. Apps are preferably available for different smart device operating systems, for example, Android and iOS. In combination with the monetization options described earlier. Such apps represent an additional opportunity to monetize event participation through placement of targeted advertising to specific devices. Targeted advertisements may be based on a participant's past or current activity, indicated preferences or interests designated during subscription or registration, etc.

Aggregation may be performed at any convenient or preferred location. For example, at the venue (e.g., stadium, etc.) where the event takes place, or at a location remote from the event venue, and subsequently delivered to the venue. For example, where a plurality of events are simultaneously being played (such as is typical with weekend American baseball or football), it may be advantageous to have a centralized aggregation facility where announcers may also verbally and/or visually contribute into the same or separate audio feeds. For example, the aggregator of FIG. 1 may support a plurality of venue events

Aggregation may also or additionally take place at a plurality of locations, as it may be advantageous to have distributed aggregation for any given RAVE. This is shown in FIG. 2, where participants are categorized by geographic areas 1, 2, etc., with each area being separately aggregated before the audio is provided to the venue. The categories need not be based on a geographical area, however, and any type of category may be defined for discrete aggregation. Though not shown in FIG. 2, the separately aggregated audio information could be collectively aggregated before being delivered to the venue location (i.e., as shown in FIG. 1).

Aggregation may be performed by, and oriented to, team affiliation. This is depicted in FIG. 3B, which shows separate aggregators for teams A and B, with the respective compiled information being delivered to the venue. This way the aggregated audio streams may be used to simulate “home” and “away” or other such categorical audience responses within the venue. For example, subscribers that registered with an affiliation to team A may have their response audio go to one of the speaker arrays. Those with affiliation to team B may go to another array. Where appropriate, the arrays are preferably established at physical locations representative of where live audience affiliations would be seated. The audio from those with no registered affiliation may get mixed to both audio feeds, either during aggregation or at the venue.

Other stadium sounding options are available to the event production facility staff, as a function of type of event or the types of aggregation implemented. For example, beyond the aggregation of team affiliation remote audiences, there may be additional audio and/or video participants, such as marching bands, cheerleaders, opening ceremony singers, live play-by-play analysis, etc. The techniques described herein may be used by any such contributors, and the aggregated live feeds can be creatively assembled for venue sounding (or viewing) at the discretion of the production staff.

### 3. Video Feed Options

In addition to audio there may be an option to have one or more video feeds (selected, for example, by the RAVE producer) coming from subscribers so that a subscriber's local camera feed gets displayed (e.g., for a few seconds) on the venue's display screen(s) analogous to the “look mom, I'm on the Jumbotron” in the legacy paradigm of live audiences. Since there will likely be many more participants desiring to see themselves on the venue display screen(s) as capabilities allow, RAVE service entities may develop incentives or threshold methods that allow RAVE producers and/or participants themselves to be categorized for “more likely” or “guaranteed” to get on display. Incentives may be, for example, based on a reward or loyalty system for past participation, signing up new subscribers, most participates at a given subscriber location (e.g., bar), electing to pay a fee for subscription and/or registration, etc.

As not all subscribers will desire to participate in delivery of their locally generated video, the subscriber may opt in or out during subscription or registration. Likewise, not all RAVE productions will necessarily support the feature, in which case the registration process may indicate the option is unavailable for the particular event.

Many modern stadia have implemented comprehensive visual display capabilities that feature a plurality of displays and/or surround imaging. These may be employed to enhance the use of RAVE video feeds by significantly increasing the numbers of participants who are able to have their locally sourced visuals put on display. Should the venue have a multiplicity of big screen televisions (such as a large sports bar or casino), similar advantage may be taken. As a component of the above reward/loyalty process, participant's images may be placed, for example, on the big/central vs. smaller display screens, and/or for more or lesser periods of time.

Subscriber participation enjoyment may be enhanced by having the venue's audio soundings and/or video displays included in the television broadcast of the event. The “RAVE effect” brings remote audiences to the venue, and thus integrating RAVE audio and video inputs as rendered, with the broadcast production, feeds back audience participation to the audience, simulating a live presence, albeit at the subscriber's remote location.

### 4. System Communications, Gateways and Participation Variations

Communication of an event for display to participants may be by any means typically used for general remote audience viewing. Examples are depicted in FIG. 1, for example, as over-the-air broadcast, cable TV or satellite delivery, as well as via the Internet. As described above, a return channel is required to feed audience audio (and optionally video) responses to aggregation and the venue. This channel is preferably the Internet, however the invention is not limited to the Internet for the return channel, which may alternatively use or include, for example, a cable TV plant's upstream or DOCSIS data channel.

No RAVE-specific communication protocol is required, however different RAVE service entities may implement preferred command and control protocols for their operations. This will likely include RAVE service entity-specific user interfaces and/or downloaded apps directed to their brand name identity. Such apps will preferably include controls and selection means for the various user subscription, registration, moniker and affiliation designations, as well as provide the user interface for participants for live event interactive processes.

Examples of live event interactive processes may be video feed opt in/out, engage/disengage control, and selection and delivery of non-verbal messaging to aggregators. For example, a RAVE user app may include buttons for encouraged or predicted team or player activity that is common during live legacy game action. Examples are the audience vocalizing “pass!”, “run!”, “steal!”, “walk him!”, “bunt!” and many, many other ways that a live audience interacts with action on the field. A RAVE app can enable similar remote participation, by allowing participants to electronically indicate their (non-vocalized) selections in real-time, and have these selections delivered along with voiced sounds to aggregators.

Aggregation of such non-verbal user inputs may be implemented separately from audio and video aggregation. For example, as a component of the entertainment value proposition, event organizers and/or aggregators may elect to aggregate user's inputs to take a vote for Most Valuable Player at the event or otherwise calculate the most (or least) desired predicted outcome of a game situation. The particular calculus may revolve around sequential field activity with windowed constraints on when users are allowed to input their choices—for example between normally occurring sports segments such as between football plays, between baseball batters, between sets of a tennis match, etc. Other options may encourage inputs to be collected for a wider window, such as quarters of a football, basketball or hockey game, innings of a baseball game, etc. Of course, the above examples may include the entirety of an event or series of events, with reward programs.

Social networks are expected to be key gateways for subscription, registration and event participation. For example, a RAVE app may link to a Facebook page or vice versa, as vehicles for, or to establish, system communications, or to engage in RAVE activities. Social networks may also support cross-subscriber socializing, such as subscriber to subscriber messaging, competition and good natured game-time harassment.

The use of the invention description as “remote audience participation” or “remote audience venue event” shall be understood to mean the inventive aspects are directed to enabling subscriber participation from locations outside the scope of where a normal audience would witness the live event in person. For example, wireless communications to mobile consumer smart appliances such as phones and tablets enables RAVE participation from virtually any location.

RAVE participation is not limited to “far” remote locations, or any particular location. For example, it is not uncommon for fans to socialize in the stadium parking lot ahead of a game—even when they are not going to enter the stands to see the action. Via RAVE this type of semi-remoteness may find additional interest: With virtually empty stands during a pandemic, for example, there will be room in the parking lot for families to have a game-day picnic, be a RAVE participant and socially distant from others.

In some embodiments, a RAVE subscriber may be a participant in the event parking lot, for example, and continue to be a participant when they walk into the venue and sit in the stands, RAVE-activated tablet in hand. For purposes of clarity, once inside the venue the participant would not be considered “remote,” however. This said, embodiments are not constrained to only “remote” applications.

One advantageous feature of RAVE is its interactive aspects, which enable participant vocal and visual responses to be provided to the venue in real time for purposes of rendering at the venue. Additionally, while RAVE may be of optimal benefit in near-empty stadia situations, RAVE participation is not so limited. RAVE service entities may decide to support remote or semi-remote participation, irrespective of the size of a venue-seated audience.

Moreover, RAVE service entities may enable participation by users who can only hear the live action, and not be able to see it. Additionally, the disclosed non-verbal participation aspects may be practiced by users who do not participate in audio or video contributions to aggregation.

### 5. System Latencies

There are many technical factors that go into RAVE production surrounding the presentation of the sounding and/or visual participant signals. In particular, maintaining close synchronization of the timing of the response presentations at the event venue is important, and an objective of the process is for the venue experience to be as close to having a live audience as possible. Though the stands may be mostly empty, there are players on the field and typically at least some presence in the stands. Lacking any attention to latency and synchronization issues, the aggregated audio feeds from hundreds or thousands of participants may well manifest itself in the sounding of incoherent noise.

Participant locations will usually be geographically distributed, and thus be variant as to latencies associated with the distribution of the live event for local (participant) display. More critical are latency factors surrounding delivery of participant responses to aggregation, aggregation processing (including abuse monitoring, discussed below), delivering the aggregated signals to the venue, and lastly, amplifying and sounding at the venue. The latter includes speed of sound latency considerations from loudspeaker locations within the venue.

Since it is anticipated that Internet-based communications will be a major enabler for RAVE (both outgoing and incoming signals), the above latencies may be exacerbated because of wide variance in the timing of Internet delivered information. RAVE production therefore requires that the aggregation processes be able to detect the degree of latency from the various factors over the spectrum of information pathways/channels, and as part of aggregation, be able to adjust relative information streams to optimize synchronization of response presentations at the venue. Depending upon the distribution architecture of aggregation locations, optimization may be implemented in stages at different locations.

At aggregation, the received live audio signals will arrive across an “earlier-to-later” spread of time. Signal processing can technically implement compensation to align the signals, however, there will be a practical limit on this. Delaying the “earlier” arriving signals to be aligned with the “later” arriving signals cannot be allowed to go beyond a point in time that sounding at the venue is negatively impacted—for example, having the remote audience venue sounding occur five seconds after the bat's crack and home run would mostly likely be unacceptable.

A plurality of technical solutions for synchronization may be found necessary to achieve optimal results. Certainly low-latency cloud data/information carriers will be preferred, and are increasingly becoming available. Additionally, compensation methods for measuring round trip time (RTT) from various venue-to-participant-to-venue locations may be used with lower weightings applied to badly out of synch (e.g., delayed) signals. Synchronization processes are preferably dynamic, implementing a continuously monitored/measured process wherein compensation is adjusted over time as latency factors change.

An implementation option enabled by distributed aggregation is to perform audio compilation at locations having similar sync compensation requirements. This capability is shown in FIG. 2. By performing compilation first, synchronization compensation can be applied to the compiled audio: a single signal, which can then be supplied to subsequent stages of aggregation, or a plurality of aggregated and synchronized signals delivered in parallel directly to the venue.

A variation enabled by the aggregation architectures of FIGS. 2 and 3A-3B is the concept of dynamic or balanced weighting of audio contributions. Unlike weighting applied for purposes of synchronization, this type of weighting is applied for purposes of adding or subtracting specific sounds to the live audio feeds. For example, much in the same way so called laugh tracks are applied to television comedy shows to ramp up or complement audience participation, desired audio tracks or sound types can be added to the live remote audience audio. The reasons for doing so in implementations of RAVE are many fold, for example, to energize the players at a venue should the live audience be slow or non-existent to materialize. In such case synthesized or recorded sounds can be advantageously added until it is no longer needed or desired, with the presence of such additive audio subsequently reduced or eliminated.

Similarly, undesirable sounds such as interference from audio feedback, low flying aircraft, annoying or abusive sounds/language, etc. can be advantageously removed or reduced from the live feeds at any point along the distribution and aggregation path. The technologies for doing so is well known to those of ordinary skill in the art and need not be detailed herein.

With experience, it may become possible to compensate for situations that have, or will predictably have, marginal or less than acceptable latency delay(s). This may involve identifying high latency-contributing elements of the overall communications chain, such as broadcast channels, ISPs, wireless providers/situations, and classifications or combinations of participant appliances. Compensation (i.e., workarounds) for all contributors of high latency may not always be possible. However, circumstances may allow, for example, a participant to tune to a game event on a broadcast channel having lower delivery latency than the same game accessible on-line. Additionally, RAVE service providers may be able provide information and suggestions to participants regarding options for improving their latency factors, such as alternate ISPs, using Wi-Fi networks instead of cellular networks, etc.

In addition to aggregation location optimization, final optimization may be implemented at the venue location. This may particularly be optimized by having technical control options over synchronization objectives, made possible using loud speaker-driven sound detection and adjustment capability at the venue. This is with respect to speed of sound factors, which may be detected and accommodated using real-time detection and synchronization adjustments. Avoiding issues related to audio feedback may be also best addressed from the venue location.

RAVE is a described as a real-time interactive remote audience participation vehicle. However, due to these latency and timing compensation requirements “real-time” will be understood to be “as practical as technically feasible while achieving optimal venue and participant interactivity results.”

The audio aggregation point receives prerecorded crowd noise from playout storage along with multiple inputs comprising audio and/or video from a participant device app. The input from the user may be a media stream as is described in the present document. The aggregation point may also receive a control signal from a production control function. This control signal controls the operation of the aggregator or the aggregation point as described throughout the present document. The production control function also may provide an input to a video selection that may include a delay. The video selection function receives inputs from the user participants, if the users have subscribed to the video option. The video may be combined and fed into a venue display such that participants are displayed. Each participant may be equipped with a device having an interactive app installed on it, and an optional television for viewing the live event. Alternatively, the device with app may be used as the display for the event. The venue audio/video is fed through a distribution network to the user participants. The distribution network may be, e.g., a satellite, terrestrial, cable of internet protocol (IP) transmission network.

### 6. Example Process Flows

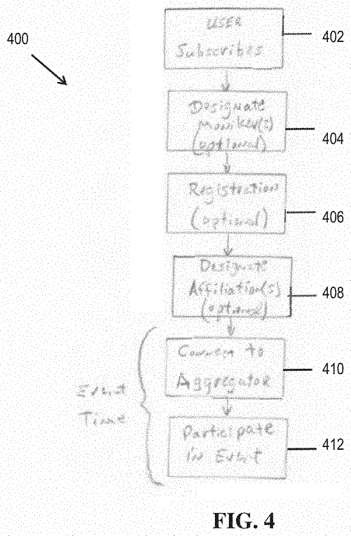

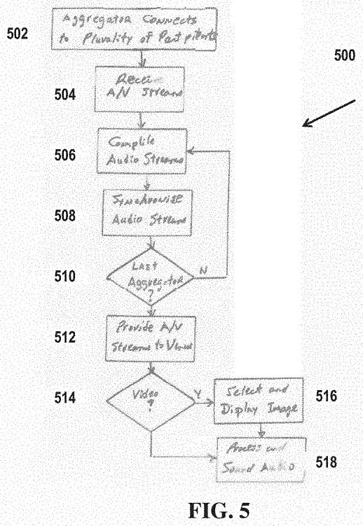

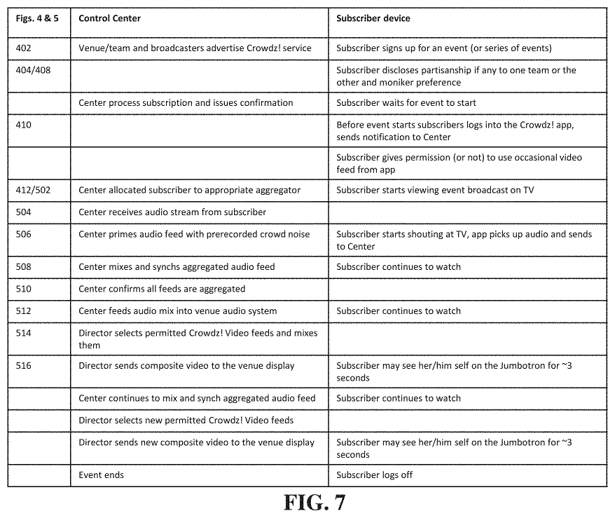

FIGS. 4 and 5 show examples of RAVE process flows. A composite flow is shown in FIG. 7, further described herein.

FIG. 4 depicts the participant process flow 400. As described above, based on service provider and/or subscriber preferences the designation of monikers and/or affiliations may be optional, as may be registration. The “event time” is shown for a typical process flow, and follows after the pre-event steps, but as described above the service entity(s) may elect to allow any of these to take place during an event. At 402, a user subscribes to RAVE. At 404, the user may (optionally) subscriber to a moniker or a team. At 406, user may perform registration (may be an optional step) in which the user provides additional data regarding user preferences, user localization and other features described herein. At 408, the user may designate his/her affiliation. At 410, the user may connect to an aggregator. At 412, the user may participate in an event through the aggregator to which the user has previously connected. The operations 410 and 412 may occur at the time of the event-e.g., start just before the live event starts, then continue contemporaneously with the live event, and end soon after the live event ends.

FIG. 5 depicts the service entity event process flow. It includes a compile and synchronize loop to provide for multi-stage aggregation, which will be understood may include aggregation at the venue. For example, at 502, an aggregator connects to a plurality of participants. At 504, the aggregator receives an audio and/or video signal from some of the participants. At 506, the aggregator compiles an aggregate audio and/or video stream. At 508, the stream may be synchronized. At 510, the aggregator may determine whether it is the last aggregator, or the aggregator that is immediately next to a venue. If not, then the aggregator may provide its aggregate stream to a next aggregator. Otherwise, the aggregator may provide its audio and/or video stream to an AV system at the venue where the real-time event is occurring. If the AV stream included video (514), an image may be identified for display at the venue (516). Otherwise, the corresponding audio may be played back at the venue (518).

The “A/V process” blocks of FIGS. 2 and 3, and the “process and sound audio” step of FIG. 5 are labels that should be understood to implement the above described venue-based sound signal processing, including synchronizing, amplification and separate speaker designated audio sounding.

FIG. 7 provides a description of the work flow shown in FIGS. 4 and 5. In FIG. 7, various tasks performed by two actors are described, with reference to similar steps described in FIG. 4 and FIG. 5. The first actor is a control center, e.g., an aggregator and/or a separate controller that manages various network-side aspects including subscription service, interfacing with the live event venue AV systems, and so on. The second actor is a subscriber device such as a mobile phone, a computer or a television.

At the network side, availability of a live event may be advertised to users. Users may become subscribers to the event by signing up for the event or through a pre-existing subscription. During the sign-up a subscriber may be allowed to provide an input regarding partisanship, a team that the user will root for, a section of the live event venue to which the user wants to subscribe to, and a moniker preference. Upon receiving user input, the control center will process the subscription and issue a confirmation to the user and the aggregator that the user is allowed access to the live event. The user will wait for the live event to start.

Before start of the event, the user may be required to “check in” to let the control center know that the user is now present for the live event. The control center may also give (or not) a permission to the user for access a live video feed of the event. The control center will assign the user to an appropriate aggregator. Once the event starts, the subscriber is able to watch and/or hear the live event. The control center begins to receive audio and/or video feed from the user. For example, the user subscriber may shout, or control an audio feedback from a user interface of the user device. The center receivers the audio feed from the live event and mix it together with users' audio feedback to generate the live audio video feed that gets broadcast to the users. The control center also ensures that the feedback from multiple users are synchronized together prior to mixing together for playback at the live event. The aggregated feed is then fed into the venue audio system. A similar process may be performed for video feeds from multiple users such that the feeds are mixed together for displaying at the live event venue. This process may be automated or may use a human operator's control to combine all videos and select a composite video that is then fed to the venue display(s). From time to time, the director may change which users are displayed to the venue display. For example, a user may see himself on the venue display for around 3 to 5 seconds, which provides sufficient feedback to the user to react to the display that is broadcast back to the user's device for display.

Once the event comes to an end, an indication is sent to the user that the event is ending and any further processing of the audio and/or video stream for the event is ended.

### 7. Avoiding System Abuse

To prevent abuse of the system, RAVE may require management over audience participation, for example, to filter offensive language and/or video images. Such management may be implemented at aggregation, or at any other convenient location, for example, downstream of aggregation at the event venue.

Because abuse filtering may require time delay processing, the “real-timeliness” of RAVE implementations may be a parameter that is technically managed and adjusted. Traditional broadcast scenarios have addressed similar issues for decades (i.e., avoidance of broadcasting offensive language or images), however, the two-way nature of RAVE compounds the challenge. This is because, unlike broadcasting's “one-to-many” nature, RAVE implements a “many-to-one” architecture, which has fundamentally more opportunity for abuse by participants.

To assist in the supervision over and management of abuse, RAVE provides for the functionality to engage and disengage participant response activity. For users, this may be as simple as offering a user interface control function (e.g., an electronic control panel button) that enables the audio and/or video feed(s) to the aggregator to be silenced. This could be under the supervision or control, for example, of a head of household (for a family den participation situation), or a tavern supervisor (at a more public participation venue).

Additional control may be provided by enabling the supervising entity to establish a desired set-up configuration for the location, and engage a “do not change” control over the user interface, control panel, etc., such that a modification to the desired configuration automatically terminates user participation. Such a control facility can be useful where different participant use case options exist that the supervision entity may not want engaged or disengaged. For example, an authority figure may want to turn off video delivery while they are momentarily absent, and can utilize such a feature to lock out participants from causing delivery of nuisance-imaging.

For RAVE production managers, the functionality of terminating the reception or aggregation of abusive incoming audio or video signals is provided, once detected. This may not only terminate the inclusion of the offending signal(s) within the aggregated signal(s), but may include the ability to remotely (i.e., from the aggregation or other control location) terminate RAVE functionality at the participant's location.

From either of the above control points (participant or aggregator location) the control authority may be empowered to reengage participation once the abuse (or threat of abuse) situation has been rectified.

RAVE production management control over delivery of participant responses from the participant location may be for other than abuse control. For example, such control may be used for congestion management of communications channels, to control the numbers of responses from a location, or to throttle responses for any number of reasons, including as a reward or incentivizing mechanism.

### 8. Example Solutions

A method of enabling remote audience participation at a live venue event, comprising receiving, at an aggregator, media inputs from one or more user device of one or more users in a subscription roster for participation in a live event; generating an aggregated media stream by processing the media inputs; and forwarding the aggregated media stream to a venue of the live event.

In some embodiments, the subscription roster is generated by allowing the one or more users to subscribe to a service.

In some embodiments, the one or more users are uniquely identified in the subscription roster.

In some embodiments, the aggregator and/or the one or more users are remotely located from the venue of the live event.

In some embodiments, the live event is available to the one or more users via a multimedia network connection.

In some embodiments, the media inputs comprise audience reactions to the live event received from the one or more user devices.

In some embodiments, the processing the media inputs includes synchronizing the media inputs from different user devices, wherein the synchronizing is partly based on propagation delays of the different user devices.

In some embodiments, the generating the aggregated media stream comprises aggregating the media streams using weights assigned to the one or more users according to corresponding subscription profiles.

In some embodiments, user identities are identified in the aggregated media streams.

In some embodiments, the subscription roster is limited to users that have subscribed to a start of the live event.

In some embodiments, the method includes adding a new user to the subscription roster for participation in the live event during occurrence of the live event.

In some embodiments, a portion of the subscription roster comprises users subscribed for access to multiple live events.

In some embodiments, the user is a person, or a group of people or a remote viewing venue.

In some embodiments, at least one user in the subscription roster is subscribed to multiple live events or has a moniker associated with the user or is affiliated with an organization identified by the user.

In some embodiments, the one or more user devices comprise a personal user device or a television.

In some embodiments, the media inputs are generated from the one or more user devices based on a user interface control on the one or more user devices.

In some embodiments, the aggregated media stream is generated by synchronizing the aggregated media stream prior to the forwarding.

In some embodiments, the method further includes omitting, from the aggregated media stream, a user's contribution to the aggregated media stream due to occurrence of a condition.

In some embodiments, the condition comprises receiving a pause or an end request from the user.

In some embodiments, the condition comprises the aggregator deciding to remove the user from the aggregated media stream due to a violation.

In some embodiments, the processing includes performing an abuse filtering check on the one or more media streams.

In some embodiments, a method of providing audience feedback at a live event, comprising: receiving, at a venue of a live event, an aggregated media stream comprising multimedia feedback to the live event from a plurality of users; and playing back the aggregated media stream using an audio or visual system at the venue.

In some embodiments, the aggregated media stream is generated using weights assigned to the one or more users according to corresponding subscription profiles.

In some embodiments, the aggregated media stream includes synchronized multimedia feedback from the plurality of users.

In some embodiments, the aggregated media stream includes a position and or a tier information for some of the plurality of users.

In some embodiments, the playing back the aggregated media stream includes using the position or the tier information to determine an output characteristic of a user's multimedia feedback by the audio or visual system.

In some embodiments, a method of allowing a user to provide live feedback to a live event includes providing an audio and/or a visual (AV) signal corresponding to a multimedia signal from a venue of a live event; capturing a user feedback to the AV signal; and providing a media stream carrying the user feedback to an aggregator.

In some embodiments, the media stream comprises user information including one or more of a user identity, a user tier, a user location, or a user seating information.

In some embodiments, the user feedback is user audio.

In some embodiments, the user feedback is user video or user image.

In some embodiments, the user feedback is captured based on user interaction with a user interface.

In some embodiments, the live event is a religious event. In some embodiments, the live event is a corporate meeting. In some embodiments, the live event is a music concert. In some embodiments, the live event is a sporting event.

In some embodiments, a system for implementing remote audience participation in live events is disclosed. The system may include one or more user devices as described herein. The system may include an aggregator as discussed herein. The system may include an audio visual display and broadcasting system at the venue of live event.

In some embodiments, live events may be advertised via social media apps. The advertisements may provide a link to subscription to the live event for participation on a one event or multi-event basis. Alternatively, the social media apps themselves may be provided access to interface with the aggregator to allow users of the social media apps to participate into the live events. The status of a user participant (whether a direct subscriber or a second-party subscriber through another app) may be reflected in a field in packet headers of packets of the media stream that are input to the aggregator.

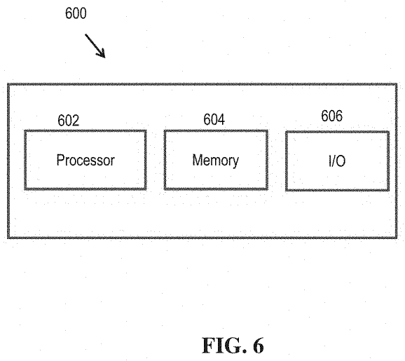

FIG. 6 is a block diagram of an example hardware platform 600 which may be used to implement methods described in the present document. The hardware platform 600 may be used, for example, to implement the aggregator, participant devices, crown noise generation function, and so on. The hardware platform 600 may include a processor 602. The processor 600 may be configured to execute program code to implement the methods described here, including, for example, media stream generation, media stream composition, and so on. The hardware platform 600 may include a memory 604. The memory 604 may be optionally external or may be internal to the processor 602. The memory 604 may be used for processing media streams, storing processor executable code, and so on. The hardware platform 600 may include an input/output interface (I/O) 606. In various embodiments, the I/O interface may be configured for receiving media streams, outputting composite media stream, receiving user inputs, outputting audio video, and so on.

### 9. Conclusion

What is unique in RAVE is the aggregation of a plurality of synchronized authentic remote audio streams for the purpose of bringing an external audience to the event venue for sounding in close to real time with venue activity. For an empty or nearly empty venue this brings an external crowd audience. But for a normally attended venue RAVE can have the effect of essentially expanding the physical seating limitations, by bringing remote participation into the venue.

Additionally, the delivery point of post-aggregation participant audio and/or video need not be limited to the venue or stadium where the event is taking place, but this content may be delivered to one or more different venues—a “remote venue.” For example, it is not unusual for a live event to be delivered to closed circuit audiences, such as to an auditorium or theater. RAVE can bring remote participation to such remote venues, instead off or in addition to the main event venue. Moreover, the feeds of RAVE participants may also be targeted to selected or specific remote venues, which may be established based on audience categories and/or the then current localized social distancing orders. The categories may be similar to the affiliations described above.

Since broadcasters first started showing live sports fans have been yelling (in vain) at their televisions. For RAVE participants, the value add is to be able to interact with the venue action, rather than being limited by the passive constraints of a couch potato simply watching TV.

Sports has always been a key part of what we call society and a vital way for humans to interact. For restricted live audience presence situations (e.g., pandemic situations) the adoption of RAVE methodologies enables stakeholders to continue to invest in making sport come alive for the masses.

It will be appreciated that, in some embodiments, remote user participation may be performed such that the audio generated at a live event venue may be matched to have a feel of a live audience audio. For example, the live event venue may be configured with speakers that are distributed at various locations throughout the arena or auditorium. Based on a user's subscription (e.g., as indicated by the user's media stream), a particular speaker at the live event and a particular volume, e.g., contribution to the aggregated audio output, may be allocated to the user. Therefore, it may be possible to provide such a localization of output audio for users. For example, each user participant, during the subscription process, may be allocated a “section” of the live event venue. Based on the user input, the user's media output (audio or video) may be played back at the section. This technical solution may be used to, for example, provide ability for users to perform “crowd waves” that are popular at live sporting events.

It will be appreciated that the above-disclosed techniques may be used for generating additional revenue opportunities for live event organizers, content providers, broadcasters, app makers and other technology providers to implement the technical solutions described in the present document.

Although the invention has been described in accordance with the embodiments shown (e.g., sports), one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

We claim:

1. A method of enabling remote audience participation at a live venue event, comprising:
receiving, at an aggregator, media inputs from one or more user device of one or more users in a subscription roster for participation in a live event;
generating an aggregated media stream by processing the media inputs; and
forwarding the aggregated media stream to a venue of the live event.

2. The method of claim 1, wherein the subscription roster is generated by allowing the one or more users to subscribe to a service.

3. The method of claim 1, wherein the one or more users are uniquely identified in the subscription roster.

4. The method of claim 1, wherein the aggregator and/or the one or more users are remotely located from the venue of the live event.

5. The method of claim 1, wherein the live event is available to the one or more users via a multimedia network connection.

6. The method of claim 1, wherein the media inputs comprise audience reactions to the live event received from the one or more user devices.

7. The method of claim 1, wherein the processing the media inputs includes synchronizing the media inputs from different user devices, wherein the synchronizing is partly based on propagation delays of the different user devices.

8. The method of claim 1, wherein the generating the aggregated media stream comprises aggregating the media streams using weights assigned to the one or more users according to corresponding subscription profiles.

9. The method of claim 1, wherein user identities are identified in the aggregated media streams.

10. The method of claim 1, wherein the subscription roster is limited to users that have subscribed to a start of the live event.

11. The method of claim 1, further including:
adding a new user to the subscription roster for participation in the live event during occurrence of the live event.

12. The method of claim 1, wherein a portion of the subscription roster comprises users subscribed for access to multiple live events.

13. The method of claim 1, wherein the user is a person, or a group of people or a remote viewing venue, and
wherein at least one user in the subscription roster is subscribed to multiple live events or has a moniker associated with the user or is affiliated with an organization identified by the user.

14. The method of claim 1, wherein the one or more user devices comprise a personal user device or a television, and
wherein the media inputs are generated from the one or more user devices based on a user interface control on the one or more user devices.

15. The method of claim 1, wherein the aggregated media stream is generated by synchronizing the aggregated media stream prior to the forwarding.

16. The method of claim 1, further including:
omitting, from the aggregated media stream, a user's contribution to the aggregated media stream due to occurrence of a condition.

17. The method of claim 16, wherein the condition comprises receiving a pause or an end request from the user or the aggregator deciding to remove the user from the aggregated media stream due to a violation.

18. The method of claim 1, wherein the processing includes performing an abuse filtering check on the one or more media streams.

19. An apparatus comprising a processor, the apparatus configured to implement a method comprising:
receiving media inputs from one or more user device of one or more users in a subscription roster for participation in a live event;
generating an aggregated media stream by processing the media inputs; and
forwarding the aggregated media stream to a venue of the live event.

20. A computer readable storage medium having processor-executable code for implementing a method comprising:
receiving media inputs from one or more user device of one or more users in a subscription roster for participation in a live event;
generating an aggregated media stream by processing the media inputs; and
forwarding the aggregated media stream to a venue of the live event.
